(19) United States
(12) Patent Application Publication
(10) Pub. No.: US 2006/0070104 A1
(43) Pub. Date: Mar. 30, 2006

(54) Video apparatus and video streaming method

(75) Inventor: Manabu Shibutani, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/229,805

(22) Filed: Sep. 20, 2005

(30) Foreign Application Priority Data
Sep. 27, 2004 (JP) 2004-280485

(51) Int. Cl. H04N 7/18; H04N 7/12

(52) U.S. Cl. 725/78; 375/240.26

(57) ABSTRACT

A video apparatus comprises means for superimposing a graphic on an image, means for coding an output signal of the graphic superimposing means, and means for streaming the output signal of the coding means to an external information processing apparatus via a network.

### CROSS-REFERENCE TO RELATED APPLICATIONS

This application is based upon and claims the benefit of priority from prior Japanese Patent Application No. 2004-280485, filed Sep. 27, 2004, the entire contents of which are incorporated herein by reference.

### BACKGROUND OF THE INVENTION

1. Field of the Invention

The present invention relates to a video apparatus having a network function and transmitting video data to an information processing apparatus such as a personal computer and a video-streaming method.

2. Description of the Related Art

Conventionally, when connecting a network apparatus to a video apparatus such as a TV tuner in a personal computer, they are connected through an interface such as Ethernet®, USB, and IEEE 1394. Accordingly, a hardware controller such as an Ethernet® controller, a USB controller, and an IEEE 1394 controller is required to be connected between an internal bus at the side of the video apparatus and an internal bus at the side of a network and further, a firm ware to control the controller is also required to be provided. This involves a problem such that a structure of a system is made complicated and increases in size or the like.

In order to solve this problem, it is proposed that a plurality of kinds of functional devices having a processor for carrying out different processing respectively such as the video apparatus and the network apparatus are combined and a bus for each of the above-described functional devices is shared so as to realize a bus sharing function of a composite device without needing a hardware controller and a firm ware for controlling the controller in order to connect the above-described functional devices (for example, refer to Japanese Patent KOKAI Publication No. 2003-223410 (paragraphs [0005] to [0008])).

In the apparatus described in the above-described publication, video data in accordance with a vide signal received by a TV tuner (MEPG-2 data) is transferred in real time to an external wireless device via a wireless LAN. Then, in the case where a condition of an electric wave in a wireless frequency band of the wireless LAN is deteriorated and a prescribed transfer band is not secured, by lowering a bit rate of the MEPG-2 data, transfer of the video data in real time is maintained.

On the other hand, in the video apparatus in recent years, GUI (Graphical User Interface) such as an OSD (On Screen Display) is superimposed on the image to indicate the information of the image displayed to a user. In addition, an image recording and reproducing apparatus displays the editing work of a recorded title by the GUI to the user in a way easy to understand and the image is displayed by a device such as a TV set connected to a video terminal.

However, the video apparatus described in Japanese Patent KOKAI Publication No. 2003-223410 could not display the image having the GUI superimposed thereon on a personal computer connected to a network. Therefore, this apparatus could not carry out the editing work to rename a name of the recorded title or the like on the personal computer connected to the network.

### BRIEF SUMMARY OF THE INVENTION

An object of the present invention is to enable an output video of a video apparatus having graphic superimposed thereon to be viewed on a device connected to the video apparatus via a network in real time.

According to an embodiment of the present invention, a video apparatus comprises means for superimposing a graphic on an image; means for coding an output signal of the graphic superimposing means; and means for streaming the output signal of the coding means to an external information processing apparatus via a network.

According to another embodiment of the present invention, a video apparatus comprises means for coding an image signal; means for recording an output signal of the coding means; means for streaming the output signal of the coding means to an external information processing apparatus via a network; means for decoding the signal recorded in the recording means; means for superimposing a graphic on one of the output signal of the decoding means and an input image signal; and switching means for selectively supplying one of the output signal of the graphic superimposing means and the input image signal to the coding means.

According to still another embodiment of the present invention, a video streaming method comprises a step of superimposing a graphic on an image signal; a step of coding the image signal having the graphic superimposed thereon; and a step of streaming the coded image signal to an external information processing apparatus via a network.

According to further embodiment of the present invention, a video streaming method comprises a step of coding an image signal; a step of recording the coded image signal in a recording medium; a step of streaming the code image signal to an external information processing apparatus via a network; a step of decoding the coded image signal recorded in the recording medium; a step of superimposing a graphic on the decoded signal and an input image signal; and a step of selectively coding one of the signal having the graphic superimposed thereon and the input image signal.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a structure of a video apparatus according to an embodiment of the present invention;

FIG. 2 is a view explaining a procedure when a personal computer requires streaming according to the embodiment of the present invention; and

FIG. 3 is a view explaining a procedure when recording the image to a hard disk drive is required during streaming according to the embodiment of the present invention.

### DETAILED DESCRIPTION OF THE INVENTION

An embodiment of a video apparatus according to the present invention will now be described with reference to the accompanying drawings.

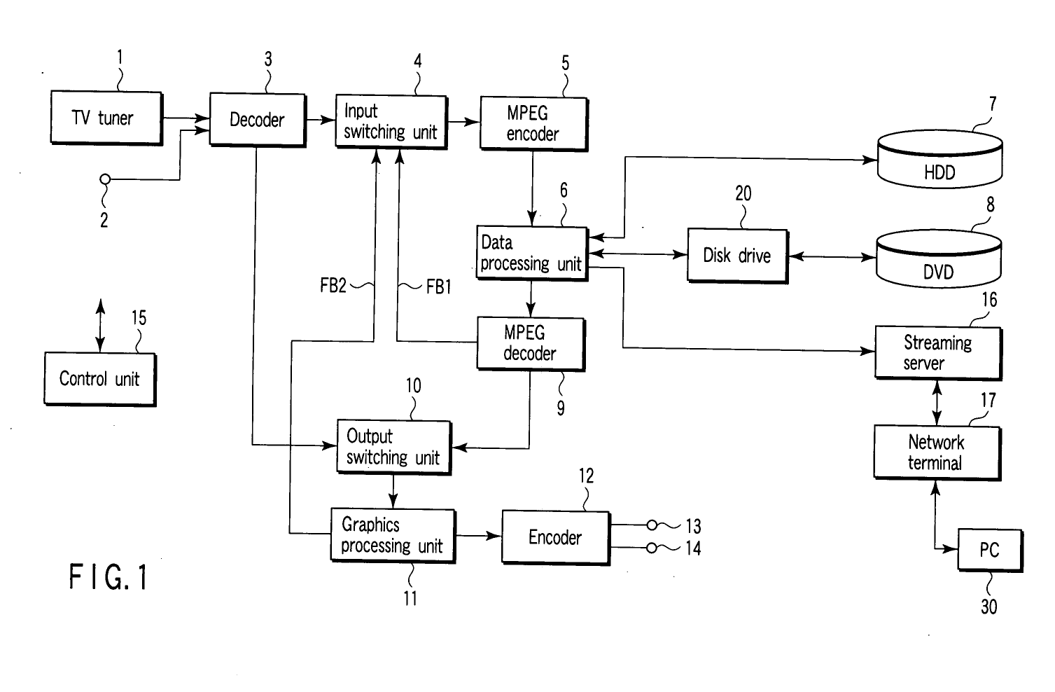

FIG. 1 is a block diagram of an image recording and reproducing apparatus capable of recording and reproducing video data including audio data on a hard disk drive (HDD) and/or a DVD (Digital Versatile Disc) as an embodiment of the video apparatus according to the present invention.

A video signal including an audio signal supplied from a TV (television) tuner 1 or an external input terminal 2 is converted to a digital signal by a decoder 3. The converted digital signal is supplied to an MPEG (Moving Picture Experts Group) encoder 5 via an input switching unit 4, and here, it is converted (compression-encoded) into the data in a format based on a DVD-VR (Video recording) standard or a DVD-V (Video) standard. The converted data is recorded in a DVD-RAM (Random Access Memory)/R (Recordable) disk that is mounted inside a hard disk drive (HDD) 7 or a DVD drive 20.

In the case of reproducing the recorded image signal, by reading the coded data from the HDD 7 or a DVD-RAM/R disk 8, this coded data is supplied to an MPEG decoder 9 via a data processing unit 6 to be decoded (expanded and decoded). The GUI (Graphical User Interface) such as the OSD (On Screen Display) is superimposed on the decoded signals by a graphic processing unit 11 via an output switching unit 10 and the video signals are output to an image output terminal 13 and an audio output terminal 14 via an encoder 12, respectively. The image signal to be output by the output terminal 13 is reproduced by a TV monitor (not illustrated) and the audio signal to be output by the audio output terminal 14 is reproduced by a speaker (not illustrated), respectively.

A sequence of the control of the entire sections according to the above-described recording and reproduction is carried out by a control unit 15 as a microcomputer.

A streaming server 16 is network-connected to a personal computer (PC) 30 via a network terminal 17, acquires the data output from the MPEG encoder 5 via the data processing unit 6 in response to a streaming request supplied from the personal computer 30, converts this data into data in a protocol of the streaming, and transfers it to the personal computer 30. In the meantime, the streaming server 16 also can be realized by software. Even if the control of this streaming server 16 is realized by the control unit 15, the function thereof is the same.

The MPEG encoder 5 is used to record the video or the like from the TV tuner 1. However, as described above, when the personal computer 30 requires the streaming, the MPEG encoder 5 is also used to create the streaming data. Since the MPEG encoder 5 can encode only one video at the same time, it is assumed that the control unit 15 carries out the processing such as the recording in priority.

The output of the MPEG decoder 9 and the output of the graphic processing unit 11 are also supplied to the input switching unit 4 as a feedback signal in addition to the output of the decoder 3. In addition, to the output switching unit 10, the output of the decoder 3 is supplied as well as the output of the MPEG decoder 9.

A first feedback path FB1 from the MPEG decoder 9 to the input switching unit 4 serves to lower a recording bit rate and encode it again in order to make the size of data to be decreased below 4.7 GB as a capacity of the DVD, for example, when copying the data that has been recorded for a long time and stored in the HDD 7 on a DVD-RAM. The feedback path FB1 returns the data so as to select the data from the output of the MPEG decoder 9, so that even if the GUI is displayed by the graphic processing unit 11 during re-encoding, its graphic data is not recorded in the DVD 8 together with the video data.

Since the data is returned from the output of the graphic processing unit 11 to the input switching unit 4 via a second feedback path FB2, if a signal input from the second feedback path FB2 is re-encoded by the MPEG encoder 5, it is possible to record the output of the MPEG decoder 9 and the image having the GUI superimposed thereon in the DVD 8 or the like.

Thus, according to the present embodiment, it is possible to realize the recording of the video signal input from the TV tuner 1 and the external input terminal 2, the recording of the data for creating a copy by reproducing the data that has been already recorded and re-encoding it, and the recording of the image having the reproduced image and the graphic superimposed thereon.

In the above description, the feedback path FB2 feeds back the output of the graphic processing unit 11 to the input switching unit 4, however, the feedback path FB2 may feedback an analog signal as the output of the encoder 12 to the input of the decoder 3. In this case, since the D/A conversion is carried out by the encoder 12 and the A/D conversion is carried out by the decoder 3, the quality of the image may be deteriorated to some degrees, however, the function to feedback the output of the MPEG decoder 9 and the data having the GUI superimposed thereon to the MPEG encoder 5 is not changed. The control of the input switching unit 4 which switches these input paths and the control of the output switching unit 10 which switches the input to the graphic processing unit 11 are also carried out by the control unit 15.

The operation of the present embodiment will be described below.

At first, the case of recording the image signal in the DVD-R media 8 in a DVD video format will be described. The setting of the input switching unit 4 is changed so as to input a signal not from the feedback path but from the decoder 3 into the MPEG encoder 5. The MPEG encoder 5 is set so as to output the DVD video format. Thereby, the data based on the DVD video format output from the MPEG encoder 5 is recorded in the DVD-R media 8 inside the DVD drive 20 via the data processing unit 6.

Next, the procedure to copy the data of the DVD-VR format already recorded in the HDD 7 on the DVD-R media 8 in the DVD video format will be described below. The setting of the input switching unit 4 is changed so as to input a signal from the feedback path FB1 therein so that the output of the MPEG encoder 9 is input into the MPEG encoder 5. If the VR format data inside the HDD 7 is reproduced simultaneously with starting the record in this condition, the data recorded inside the HDD 7 can be copied on the DVD-R media in the DVD video format. At this time, even if the progress condition of copying is displayed by superimposing using graphic by means of the graphic processing unit 11, the feedback path FB1 feedbacks only the output of the MPEG decoder 9, so that only the output of the MPEG decoder 9 is recorded in the DVD-R media 8 and no graphic is superimposed and recorded therein.

Subsequently, the processing to record the menu of the DVD video format in the DVD-R media 8 will be described.

On the menu of the DVD video format, the name of the recorded title, a thumbnail image, and the recording time or the like are displayed and the menu is recorded in the MPEG-2 format. A menu screen is created by the graphic processing unit 11, however, the graphic processing unit 11 cannot output the data in the MPEG-2 format, so that compression into the MPEG-2 format is to be carried out by the MPEG encoder 5.

If the user designates the creation of the menu, the input switching unit 4 is switched so as to select the second feedback path FB2 for returning the output of the graphic processing unit 11 to the MPEG encoder 5. After that, by superimposing the graphic illustrated by the graphic processing unit 11 on the image reproduced from the MPEG decoder 9, a menu image is created. This menu image is input to the MPEG encoder 5 via the feedback path FB2 and here, the data for the menu in the MPEG-2 format is created.

To the menu data in the DVD video format, the information that is called a sub picture is added. In this sub picture, the information such as the selected color when the user selects a button in the menu by a remote controller or the like is described. The control unit 15 creates this sub picture and multiplies it with the MPEG-2 data that is created by the MPEG encoder 5.

The menu data of the DVD video format created in this way is recorded in the DVD-R media 8.

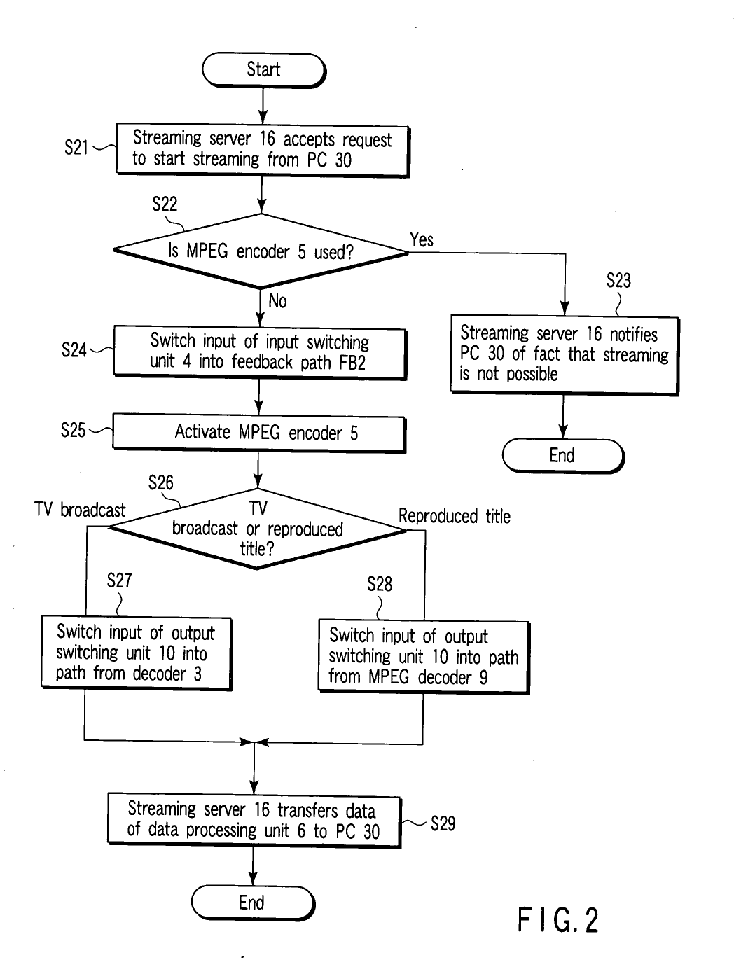

The operation when the personal computer 30 requires the streaming will be described below with reference to a flow chart of FIG. 2.

If the personal computer 30 connected to the present image recording and reproducing apparatus requires start of streaming, the streaming server 16 accepts the request to start the streaming via the network terminal 17 (step S21). The control unit 15 determines whether the MPEG encoder 5 has been used or not, namely, whether the apparatus is recording the data (step S22). Then, if the MPEG encoder 5 is used, in order to precede recording, the streaming server 16 notifies the personal computer 30 via the network terminal 17 of the fact that the streaming is not possible (step S23).

If the MPEG encoder 5 is not used, the input path of the input switching unit 4 is switched to the feedback path FB2 as the output of the graphic processing unit 11 (step S24) and the MPEG encoder 5 is activated (step S25). At this time, in the case of streaming the image data from the TV tuner 1 and the external input terminal 2, the path from the decoder 3 is selected to input the data into the output switching unit 10 (steps S26, S27), and in the case of streaming the title recorded in the HDD 7 or the DVD 8, the path from the MPEG decoder 9 is selected (steps S26, S28).

If the MPEG encoder 5 starts encoding, the streaming server 16 acquires the output data of the MPEG encoder 5 from the data processing unit 6, and, if necessary, the data is processed into the data for streaming, and then, the data is transferred (streaming) to the personal computer 30 via the network terminal 17 (step S29).

Thus, since a signal viewed by the personal computer 30 is a signal that is supplied from the graphic processing unit 11 to the MEPG encoder 5 via the feedback path FB2, this signal is the same as the signal displayed on the TV monitor and it is streamed with the graphic superimposed thereon.

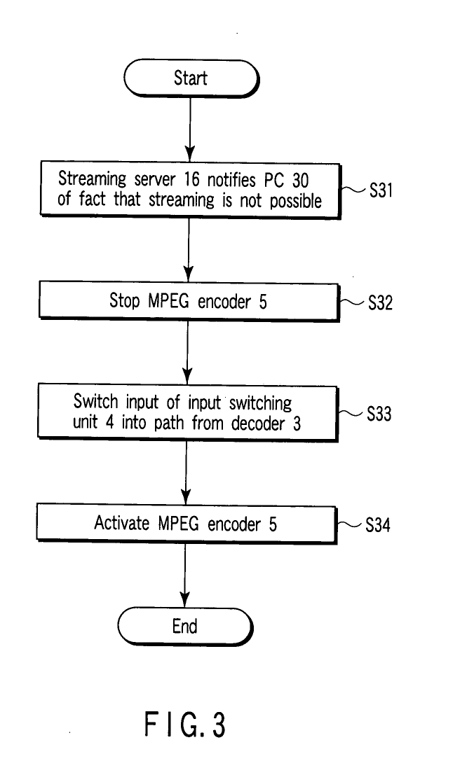

Next, the operation when the TV program is required to be recorded in a HDD or the like during streaming will be described below with reference to a flow chart of FIG. 3.

When the TV program is required to be recorded in the HDD during streaming, the streaming server 16 notifies the personal computer 30 of the fact that streaming is impossible (step S31). Then, the control unit 15 stops the operation of the MPEG encoder 5 once (step S32) to switch the input path of the input switching unit 4 from the feedback path FB2 from the graphic processing unit 11 into the path from the decoder 3 (step S33). Thereby, the streaming is stopped. After that, the MPEG encoder 5 is activated to record a signal from the TV tuner 1 in the HDD 7 (step S34). In this way, although the MPEG encoder 5 is used for both of recording and streaming, it is possible to precede the recording.

As described above, according to the present embodiment, by connecting the image having the graphic to be output to the TV monitor or the like superimposed thereon to the input of the MPEG encoder 5 via the feedback path FB2 and transferring the encoded data from the streaming server 16 to the personal computer 30, in the personal computer 30 with the same condition as the TV monitor, it is possible to view the TV image in real time and view the reproduced image in real time. Therefore, since the image having the graphic superimposed thereon is fed back to an encoder, the output image of the video apparatus having the graphic superimposed thereon can be viewed in real time on a device that is network-connected to the video apparatus.

Further, according to the present invention, there is provided a video streaming method comprising the steps of coding an image signal; recording the coded image signal in a recording medium; streaming the code image signal to an external information processing apparatus via a network; decoding the coded image signal recorded in the recording medium; superimposing a graphic on the decoded signal and an input image signal; and selectively coding one of the signal having the graphic superimposed thereon and the input image signal. The video streaming method may further comprises a step of displaying the signal having the graphic superimposed thereon.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. A video apparatus comprising:
means for superimposing a graphic on an image;
means for coding an output signal of the graphic superimposing means; and
means for streaming the output signal of the coding means to an external information processing apparatus via a network.

2. The video apparatus according to claim 1, further comprising means for displaying the output signal of the graphic superimposing means.

3. The video apparatus according to claim 1, further comprising means for selectively inputting an input image signal or the output signal of the graphic superimposing means to the coding means.

4. The video apparatus according to claim 1, further comprising means for recording the output signal of the coding means;
means for decoding the signal recorded in the recording means; and
means for selectively inputting one of the output signal of the decoding means and the input image signal to the graphic superimposing means.

5. A video apparatus comprising:
means for coding an image signal;
means for recording an output signal of the coding means;
means for streaming the output signal of the coding means to an external information processing apparatus via a network;
means for decoding the signal recorded in the recording means;
means for superimposing a graphic on one of the output signal of the decoding means and an input image signal; and
switching means for selectively supplying one of the output signal of the graphic superimposing means and the input image signal to the coding means.

6. The video apparatus according to claim 5, further comprising means for displaying the output signal of the graphic superimposing means.

7. A video streaming method comprising the steps of:
superimposing a graphic on an image signal;
coding the image signal having the graphic superimposed thereon; and
streaming the coded image signal to an external information processing apparatus via a network.

8. The video streaming method according to claim 7, further comprising a step of displaying the image signal having the graphic superimposed thereon.

9. The video streaming method according to claim 7, further comprising a step of selectively coding one of an input image signal and the image signal having the graphic superimposed thereon.

10. The video streaming method according to claim 7, further comprising the steps of:
recording the coded image signal in a recording medium;
decoding the coded image signal recorded in the recording medium; and
selectively superimposing the graphic on one of the decoded signal and the input image signal.
